(19) United States
(12) Patent Application Publication
(10) Pub. No.: US 2016/0043878 A1
(43) Pub. Date: Feb. 11, 2016

(54) MULTICAST COMMUNICATIONS METHOD AND AGGREGATION SWITCH

(71) Applicant: HUAWEI TECHNOLOGIES CO., LTD., Shenzhen (CN)

(72) Inventors: Weiguo HAO, Nanjing (CN); Yisong LIU, Beijing (CN)

(73) Assignee: HUAWEI TECHNOLOGIES CO., LTD., Shenzhen (CN)

(21) Appl. No.: 14/885,500

(22) Filed: Oct. 16, 2015

Related U.S. Application Data
(63) Continuation of application No. PCT/CN2014/075760, filed on Apr. 21, 2014.

(30) Foreign Application Priority Data
Apr. 19, 2013 (CN) 201310137909.7

(51) Int. Cl. H04L 12/18; H04L 12/761

(52) U.S. Cl. CPC H04L 12/185; H04L 45/16

(57) ABSTRACT

The application provides a multicast communications method and an aggregation switch, which can implement on-demand replication of multicast traffic. The method includes: an aggregation switch (AGG) acquires a multicast group address link state protocol data unit (GM LSP) packet sent by an access switch (ACC); the AGG compares multicast join information in the GM LSP packet with multicast join information stored in the AGG, to obtain a comparison result, and the AGG updates the multicast join information stored in the AGG according to the comparison result. The AGG generates a preset-protocol packet by using changed multicast join information in the comparison result according to a preset format, where the preset-protocol packet is an Internet Group Management Protocol (IGMP) packet or a Protocol Independent Multicast (PIM) packet. The AGG sends the preset-protocol packet to a first multicast router.

### CROSS-REFERENCE TO RELATED APPLICATIONS

This application is a continuation of International Application No. PCT/CN2014/075760, filed on Apr. 21, 2014, which claims priority to Chinese Patent Application No. 201310137909.7, filed on Apr. 19, 2013, both of which are incorporated by reference in their entireties.

### TECHNICAL FIELD

The present invention relates to the communications field, and in particular, to a multicast communications method and an aggregation switch.

### BACKGROUND

A TRILL (Transparent Interconnect of Lots of Links, Transparent Interconnection of Lots of Links) network is a network formed by RB (Route Bridge, routing bridge device) devices on which the TRILL protocol runs. The TRILL network may be applied to multiple types of scenarios; when the TRILL network is applied in an IPTV (Internet Protocol Television, Internet Protocol television) scenario, an AGG (Aggregation Switch, aggregation switch) and an ACC (Access Switch, access switch) are connected to form the TRILL network, where the AGG is connected to a multicast router, the ACC is connected to a receiver of a multicast group, and a last-hop router in the multicast router is connected to a multicast source. The receiver of the multicast group sends an IGMP (Internet Group Management Protocol, Internet Group Management Protocol) packet to the ACC, and the ACC transforms the IGMP packet to an LSP (Link State PDU, link state protocol data unit) packet carrying a Group Address TLV (Group Address Tag-Length-Value, multicast group address type-length-value) to order a program of the multicast source. In particular, the LSP packet carrying the Group Address TLV is called a GM LSP (Group Mac Link State PDU, multicast group address link state protocol data unit) packet, and the GM LSP packet needs to pass the AGG and the router connected to the AGG, and be transferred to the last-hop router, so that the last-hop router acquires a multicast stream from the multicast source, and transfers the multicast stream to the receiver of the multicast group through a network.

In the prior art, the GM LSP packet is sent between the AGG and a first multicast router in a static multicast manner, where the first multicast router is a multicast router directly connected to the AGG, which cannot implement on-demand replication of multicast traffic, and there is a waste of link bandwidth between the AGG and the first multicast router.

### SUMMARY

Embodiments of the present invention provide a multicast communications method and an aggregation switch, which can implement on-demand replication of multicast traffic and save link bandwidth.

In order to achieve the foregoing objectives, the embodiments of the present invention adopt the following technical solutions:

According to a first aspect, the present invention provides a multicast communications method, applied to an AGG and including:

acquiring a GM LSP packet sent by an ACC;

comparing multicast join information in the GM LSP packet with multicast join information that is stored in the AGG and updated last time, to obtain a comparison result, and updating, according to the comparison result, the multicast join information stored in the AGG;

when there is changed multicast join information in the comparison result, generating, according to the comparison result, a preset-protocol packet according to a preset format, where the preset-protocol packet is an IGMP (Internet Group Management Protocol, Internet Group Management Protocol) packet or a PIM (Protocol Independent Multicast, Protocol Independent Multicast) packet; and

sending the preset-protocol packet to a first multicast router, so that the first multicast router generates a multicast forwarding entry according to the preset-protocol packet.

With reference to the first aspect, in a first possible implementation manner of the first aspect, the GM LSP packet is a TRILL LSP packet; and the multicast join information in the GM LSP packet includes: a VLAN (Virtual Local Area Network, virtual local area network) identifier and multicast group information corresponding to the VLAN identifier, or the multicast join information in the GM LSP packet includes: a VLAN identifier and multicast source information and multicast group information that are corresponding to the VLAN identifier.

With reference to the first aspect and the first possible implementation manner of the first aspect, in a second possible implementation manner of the first aspect, the comparing multicast join information in the GM LSP packet with multicast join information that is stored in the AGG and updated last time, to obtain a comparison result includes:

when the multicast join information in the GM LSP packet includes a VLAN identifier and multicast group information corresponding to the VLAN identifier,

classifying and combining, according to the VLAN identifier, the multicast join information that is stored in the AGG and updated last time, to obtain first multicast join information, where the first multicast join information is each VLAN identifier and multicast group information corresponding to each VLAN identifier that are stored in the AGG;

classifying and combining, according to the VLAN identifier, the multicast join information in the GM LSP packet, to obtain second multicast join information, where the second multicast join information is each VLAN identifier and multicast group information corresponding to each VLAN identifier that are in the GM LSP packet; and

comparing the first multicast join information with the second multicast join information to obtain the comparison result, where the comparison result includes:

when the first multicast join information is compared with the second multicast join information, and there is newly added multicast group information in a specific VLAN of the second multicast join information, the comparison result includes the newly added multicast group information; and

when the first multicast join information is compared with the second multicast join information, and there is reduced multicast group information in a specific VLAN of the second multicast join information, the comparison result includes the reduced multicast group information; or

when the multicast join information in the GM LSP packet includes a VLAN identifier and multicast source information and multicast group information that are corresponding to the VLAN identifier,

classifying and combining, according to the VLAN identifier, the multicast join information that is stored in the AGG and updated last time, to obtain first multicast join information, where the first multicast join information is each VLAN identifier and multicast source information and multicast group information corresponding to each VLAN identifier that are stored in the AGG;

classifying and combining, according to the VLAN identifier, the multicast join information in the GM LSP packet, to obtain second multicast join information, where the second multicast join information is each VLAN identifier and multicast source information and multicast group information corresponding to each VLAN identifier that are stored in the GM LSP packet; and

comparing the first multicast join information with the second multicast join information to obtain the comparison result, where the comparison result includes:

when the first multicast join information is compared with the second multicast join information, and there is newly added multicast source information and multicast group information in a specific VLAN of the second multicast join information, the comparison result includes the newly added multicast source information and multicast group information; and

when the first multicast join information is compared with the second multicast join information, and there is reduced multicast source information and multicast group information in a specific VLAN of the second multicast join information, the comparison result includes the reduced multicast source information and multicast group information.

With reference to the second possible implementation manner of the first aspect, in a third possible implementation manner of the first aspect, when the preset-protocol packet is an IGMP packet, the generating, according to the comparison result, a preset-protocol packet according to a preset format includes:

generating, by the AGG according to the comparison result, an IGMP packet according to the preset format, where the preset format includes: a V1 format, a V2 format, or a V3 format, where V1, V2, and V3 are version numbers of the IGMP protocol.

With reference to the third possible implementation manner of the first aspect, in a fourth possible implementation manner of the first aspect, when the preset format is the V1 format or the V2 format, and when there is the newly added multicast group information in the comparison result, the generating, according to the comparison result, an IGMP packet according to the preset format includes:

generating, by the AGG, a first IGMP report packet according to the newly added multicast join information in the comparison result, where the first IGMP report packet is generated according to the newly added multicast group information;

when the preset format is the V3 format, and when there is the newly added multicast group information in the comparison result, or there is the newly added multicast source information and multicast group information in the comparison result, the generating, according to the comparison result, an IGMP packet according to the preset format includes:

generating, by the AGG, an allow packet according to the newly added multicast join information in the comparison result, where the allow packet is generated according to the newly added multicast group information or according to the newly added multicast source information and multicast group information;

when the preset format is the V1 format or the V2 format, and when there is the reduced multicast group information in the comparison result, the generating, according to the comparison result, an IGMP packet according to the preset format includes:

generating, by the AGG, a leave indication packet according to the reduced multicast join information in the comparison result, where the leave indication packet is generated according to the reduced multicast group information; and

when the preset format is the V3 format, and when there is the reduced multicast group information in the comparison result, or there is the reduced multicast source information and multicast group information in the comparison result, the generating, according to the comparison result, an IGMP packet according to the preset format includes:

generating, by the AGG, a leave packet according to the reduced multicast join information in the comparison result, where the leave packet is generated according to the reduced multicast group information or according to the reduced multicast source information and multicast group information.

With reference to the third possible implementation manner of the first aspect, in a fifth possible implementation manner of the first aspect, when the preset format is the V2 format, or when the preset format is the V3 format, the generating, according to the comparison result, an IGMP packet according to the preset format includes:

receiving, by the AGG, a group-specific query packet sent by the first multicast router, where the group-specific query packet includes a specific VLAN identifier; and

generating, by the AGG, a second IGMP report packet according to the comparison result, where the second IGMP report packet is generated according to the updated multicast join information that is stored in the AGG and updated last time.

With reference to the third possible implementation manner of the first aspect, in a sixth possible implementation manner of the first aspect, when the preset-protocol packet is a PIM packet,

when there is the newly added multicast group information in the comparison result, the generating, according to the comparison result, a preset-protocol packet according to a preset format includes:

generating, by the AGG, a PIM SM Join (Protocol Independent Multicast Service Message Join, Protocol Independent Multicast service join message) according to the newly added multicast join information in the comparison result, where the PIM SM Join is generated according to the newly added multicast group information;

when there is the newly added multicast source information and multicast group information in the comparison result, the generating, according to the comparison result, a preset-protocol packet according to a preset format includes:

generating, by the AGG, a PIM SSM Join (Protocol Independent Multicast Source Specific Multicast Join, Protocol Independent Multicast source specific multicast join message) according to the added multicast join information in the comparison result, where the PIM SSM Join is generated according to the newly added multicast source information and multicast group information;

when there is the reduced multicast group information in the comparison result, the generating, according to the comparison result, a preset-protocol packet according to a preset format includes:

generating, by the AGG, a PIM SM Prune (Protocol Independent Multicast Service Message Prune, Protocol Independent Multicast service prune message) according to the reduced multicast join information in the comparison result, where the PIM SM Prune is used to delete the reduced multicast group information; and

when there is the reduced multicast source information and multicast group information in the comparison result, the generating, according to the comparison result, a preset-protocol packet according to a preset format includes:

generating, by the AGG, a PIM SSM Prune (Protocol Independent Multicast Source Specific Multicast Prune, Protocol Independent Multicast source specific multicast prune message) according to the reduced multicast join information in the comparison result, where the PIM SSM Prune is used to delete the reduced multicast source information and multicast group information.

According to a second aspect, the present invention provides an AGG, including:

an acquiring unit, configured to acquire a GM LSP packet sent by an ACC;

a storage unit, configured to store multicast join information that is updated last time;

a comparing unit, configured to compare multicast join information in the GM LSP packet acquired by the acquiring unit with the multicast join information in the storage unit, to obtain a comparison result, send the comparison result to a generating unit, and update the multicast join information in the storage unit according to the comparison result;

the generating unit, configured to receive the comparison result sent by the comparing unit, and when there is changed multicast join information in the comparison result, generate, according to the comparison result, a preset-protocol packet according to a preset format, where the preset-protocol packet is an Internet Group Management Protocol IGMP packet or a Protocol Independent Multicast PIM packet; and

a sending unit, configured to send the preset-protocol packet generated by the generating unit to a first multicast router, so that the first multicast router generates a multicast forwarding entry according to the preset-protocol packet.

With reference to the second aspect, in a first possible implementation manner of the second aspect, the GM LSP packet is a TRILL LSP packet; and the multicast join information in the GM LSP packet includes: a VLAN identifier and multicast group information corresponding to the VLAN identifier, or the multicast join information in the GM LSP packet includes: a VLAN identifier and multicast source information and multicast group information that are corresponding to the VLAN identifier.

With reference to the second aspect and the first possible implementation manner of the second aspect, in a second possible implementation manner of the second aspect, the comparing unit is specifically configured to:

when the multicast join information in the GM LSP packet includes a VLAN identifier and multicast group information corresponding to the VLAN identifier,

classify and combine, according to the VLAN identifier, the multicast join information stored in the storage unit, to obtain first multicast join information, where the first multicast join information is each VLAN identifier and multicast group information corresponding to each VLAN identifier that are stored in the AGG;

classify and combine, according to the VLAN identifier, the multicast join information in the GM LSP packet acquired by the acquiring unit, to obtain second multicast join information, where the second multicast join information is each VLAN identifier and multicast group information corresponding to each VLAN identifier that are in the GM LSP packet; and

compare the first multicast join information with the second multicast join information to obtain the comparison result, where the comparison result includes:

when the first multicast join information is compared with the second multicast join information, and there is newly added multicast group information in a specific VLAN of the second multicast join information, the comparison result includes the newly added multicast group information; and

when the first multicast join information is compared with the second multicast join information, and there is reduced multicast group information in a specific VLAN of the second multicast join information, the comparison result includes the reduced multicast group information; or

when the multicast join information in the GM LSP packet includes a VLAN identifier and multicast source information and multicast group information that are corresponding to the VLAN identifier,

classify and combine, according to the VLAN identifier, the multicast join information stored in the storage unit, to obtain first multicast join information, where the first multicast join information is each VLAN identifier and multicast source information and multicast group information corresponding to each VLAN identifier that are stored in the AGG;

classify and combine, according to the VLAN identifier, the multicast join information in the GM LSP packet acquired by the acquiring unit, to obtain second multicast join information, where the second multicast join information is each VLAN identifier and multicast source information and multicast group information corresponding to each VLAN identifier that are stored in the GM LSP packet; and

compare the first multicast join information with the second multicast join information to obtain the comparison result, where the comparison result includes:

when the first multicast join information is compared with the second multicast join information, and there is newly added multicast source information and multicast group information in a specific VLAN of the second multicast join information, the comparison result includes the newly added multicast source information and multicast group information; and

when the first multicast join information is compared with the second multicast join information, and there is reduced multicast source information and multicast group information in a specific VLAN of the second multicast join information, the comparison result includes the reduced multicast source information and multicast group information.

With reference to the second possible implementation manner of the second aspect, in a third possible implementation manner of the second aspect, when the preset-protocol packet is an IGMP packet, the generating unit is specifically configured to:

receive the comparison result sent by the comparing unit, and generate, according to the comparison result, an IGMP packet according to the preset format, where the preset format includes: a V1 format, a V2 format, or a V3 format, where V1, V2, and V3 are version numbers of the IGMP protocol.

With reference to the third possible implementation manner of the second aspect, in a fourth possible implementation manner of the second aspect, when the preset format is the V1 format or the V2 format, and there is the newly added multicast group information in the comparison result, the generating unit is specifically configured to:

receive the comparison result sent by the comparing unit, and generate a first IGMP report packet according to the newly added multicast join information in the comparison result, where the first IGMP report packet is generated according to the newly added multicast group information;

when the preset format is the V3 format, and when there is the newly added multicast group information in the comparison result, or there is the newly added multicast source information and multicast group information in the comparison result, the generating unit is specifically configured to:

receive the comparison result sent by the comparing unit, and generate an allow packet according to the newly added multicast join information in the comparison result, where the allow packet is generated according to the newly added multicast group information or according to the newly added multicast source information and multicast group information;

when the preset format is the V1 format or the V2 format, and when there is the reduced multicast group information in the comparison result, the generating unit is specifically configured to:

receive the comparison result sent by the comparing unit, and generate a leave indication packet according to the reduced multicast join information in the comparison result, where the leave indication packet is generated according to the reduced multicast group information; and

when the preset format is the V3 format, and when there is the reduced multicast group information in the comparison result, or there is the reduced multicast source information and multicast group information in the comparison result, the generating unit is specifically configured to:

receive the comparison result sent by the comparing unit, and generate a leave packet according to the reduced multicast join information in the comparison result, where the leave packet is generated according to the reduced multicast group information or according to the reduced multicast source information and multicast group information.

With reference to the third possible implementation manner of the second aspect, in a fifth possible implementation manner of the second aspect, when the preset format is the V2 format, or when the preset format is the V3 format, the generating unit is specifically configured to:

receive a group-specific query packet sent by the first multicast router, where the group-specific query packet includes a specific VLAN identifier; and

generate a second IGMP report packet according to the comparison result, where the second IGMP report packet is generated according to the updated multicast join information.

With reference to the third possible implementation manner of the second aspect, in a sixth possible implementation manner of the second aspect, when the preset-protocol packet is a PIM packet,

when there is the newly added multicast group information in the comparison result, the generating unit is specifically configured to:

receive the comparison result of the comparing unit, and generate a PIM SM Join according to the newly added multicast join information in the comparison result, where the PIM SM Join is generated according to the newly added multicast group information;

when there is the newly added multicast source information and multicast group information in the comparison result, the generating unit is specifically configured to:

receive the comparison result of the comparing unit, and generate the PIM SSM Join according to the newly added multicast join information in the comparison result, where the PIM SSM Join is generated according to the newly added multicast source information and multicast group information;

when there is the reduced multicast group information in the comparison result, the generating unit is specifically configured to:

receive the comparison result of the comparing unit, and generate the PIM SM Prune according to the reduced multicast join information in the comparison result, where the PIM SM Prune is used to delete the reduced multicast group information; and

when there is the reduced multicast source information and multicast group information in the comparison result, the generating unit is specifically configured to:

receive the comparison result of the comparing unit, and generate the PIM SSM Prune according to the reduced multicast join information in the comparison result, where the PIM SSM Prune is used to delete the reduced multicast source information and multicast group information.

The embodiments of the present invention provide a multicast communications method and an aggregation switch. The multicast communications method includes: acquiring, by an AGG, a GM LSP packet sent by an ACC; comparing multicast join information in the GM LSP packet with multicast join information that is stored in the AGG and undated last time, to obtain a comparison result, and updating, according to the comparison result, the multicast join information stored in the AGG; when there is changed multicast join information in the comparison result, generating, according to the comparison result, a preset-protocol packet according to a preset format, where the preset-protocol packet is an Internet Group Management Protocol IGMP packet or a Protocol Independent Multicast PIM packet; and sending the preset-protocol packet to a first multicast router, so that the first multicast router generates a multicast forwarding entry according to the preset-protocol packet. In this way, the acquired GM LSP packet is compared with the GM LSP packet stored in the AGG; and when there is the changed multicast join information in the comparison result, the preset-protocol packet is generated according to the comparison result, and the preset-protocol packet is sent to the first multicast router, where the comparison result includes newly added or reduced multicast group information, or includes newly added or reduced multicast source information and multicast group information. Compared with the prior art, the newly added or reduced multicast group information, or the newly added or reduced multicast source information and multicast group information is actively sent to the first multicast router, which implements on-demand sending on a path from the AGG to the first multicast router, thereby saving link bandwidth from the AGG to the first multicast router.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a multicast communications method according to an embodiment of the present invention;

FIG. 2 is a schematic structural diagram of an interactive television network according to an embodiment of the present invention;

FIG. 3 is a flowchart of another multicast communications method according to an embodiment of the present invention;

FIG. 4 is a schematic structural diagram of an AGG according to an embodiment of the present invention; and

FIG. 5 is a schematic structural diagram of another AGG according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

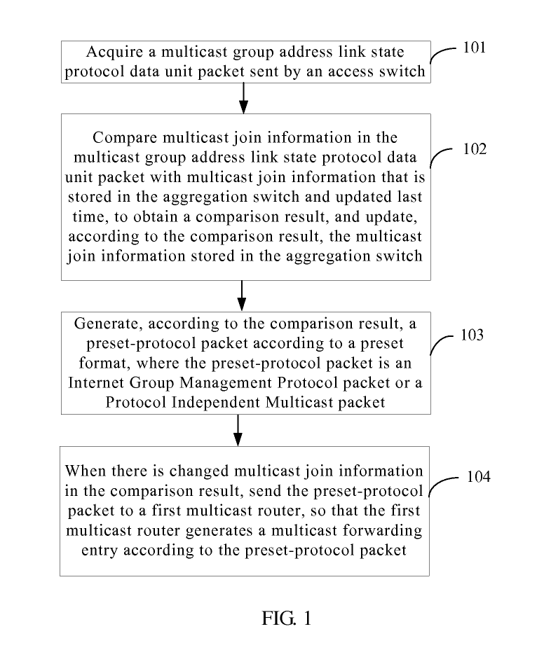

An embodiment of the present invention provides a multicast communications method applied to an AGG. As shown in FIG. 1, the method includes:

101. Acquire a GM LSP packet sent by an ACC.

The GM LSP packet includes a VLAN identifier of 12 bits and multicast group information that is corresponding to the VLAN identifier, or a VLAN identifier and multicast source information and multicast group information that are corresponding to the VLAN identifier, or a fine grained label (Fine Grained Label, FGL) and multicast group information that is corresponding to the fine grained label, or a fine grained label and multicast source information and multicast group information that are corresponding to the fine grained label. It should be noted that the fine grained label is a VLAN identifier of 24 bits, and therefore, the VLAN identifier in the embodiment of the present invention may refer to a VLAN identifier of 12 bits, or may refer to a VLAN identifier of 24 bits.

102. Compare multicast join information in the GM LSP packet with multicast join information that is stored in the AGG and updated last time, to obtain a comparison result, and update, according to the comparison result, the multicast join information stored in the AGG.

103. When there is changed multicast join information in the comparison result, generate, according to the comparison result, a preset-protocol packet according to a preset format, where the preset-protocol packet is an Internet Group Management Protocol IGMP packet or a Protocol Independent Multicast PIM packet.

104. Send the preset-protocol packet to a first multicast router, so that the first multicast router generates a multicast forwarding entry according to the preset-protocol packet.

In this way, the acquired GM LSP packet is compared with the GM LSP packet stored in the AGG; and when there is the changed multicast join information in the comparison result, the preset-protocol packet is generated according to the comparison result, and the preset-protocol packet is sent to the first multicast router, where the comparison result includes newly added or reduced multicast group information, or includes newly added or reduced multicast source information and multicast group information. Compared with the prior art, the newly added or reduced multicast group information, or the newly added or reduced multicast source information and multicast group information is actively sent to the first multicast router, which implements on-demand sending on a path from the AGG to the first multicast router, thereby saving link bandwidth from the AGG to the first multicast router.

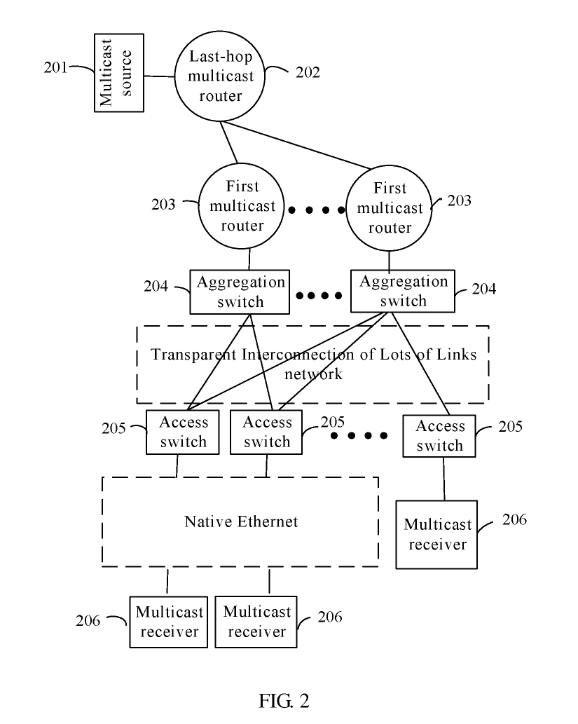

It should be noted that this multicast communications method may be implemented between a TRILL network and a multicast router. The TRILL network not only may be applied to a data center scenario, but also may be applied to an IPTV scenario. FIG. 2 is a schematic structural diagram of an interactive television network IPTV. In the IPTV network, an ACC 205 is configured to directly connect a receiver 206 of multicast source information or multicast group information; and the ACC 205 may be directly connected to the receiver 206 of multicast source information or multicast group information, or may access the receiver 206 of multicast source information or multicast group information through a Native ETH (Native Ethernet, native Ethernet). An AGG 204 is an aggregation point of multiple ACCs 205, and the TRILL network is between the ACC 205 and the AGG 204. The AGG 204 accesses a on-demand request of a multicast receiver 206 by using the ACC 205, and sends, by using a first multicast router 203 and a last-hop multicast router 202, to a multicast source 201 a packet carrying multicast group information, or multicast source information and multicast group information in the on-demand request, for ordering a program.

The AGG, the ACC, and a forwarding device between the AGG and the ACC form the TRILL network; and the TRILL protocol runs between the AGG and the ACC. The TRILL protocol is a routing protocol based on link state calculation over the TRILL network, a device running the TRILL protocol is called an RB (Route Bridge, routing bridge device), and the AGG and the ACC belong to RB devices of a TRILL network edge. The RB learns information about a TRILL network topology and distribution tree by using information in the TRILL protocol. Each RB uses the device itself as a source node, and generates, by using a shortest path tree algorithm, a unicast forwarding table to another RB; and the RB uses a root of each distribution tree as a source node, and generates, by using the shortest path tree algorithm, a distribution tree forwarding table to another RB.

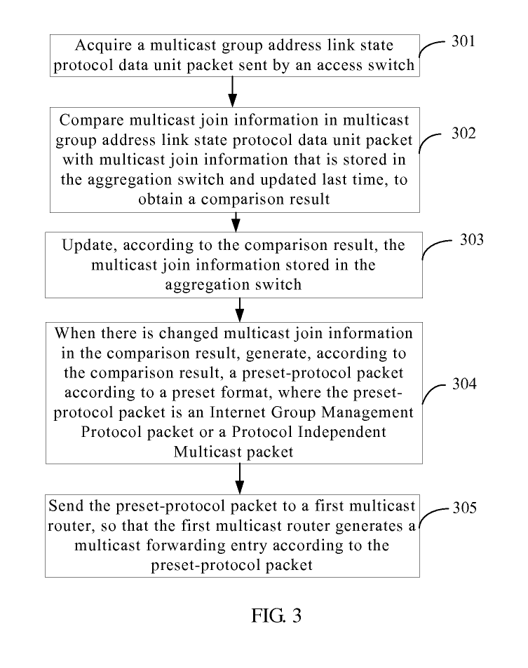

The multicast communications method provided by the embodiment of the present invention may further be applied to multicast communications in an IPTV scenario, and is executed by an AGG. A specific process of executing the multicast communications method is shown in FIG. 3, and includes:

301. Acquire a GM LSP packet sent by an ACC.

First, the ACC acquires a GM LSP packet sent by a multicast group receiver; then, the ACC sends the GM LSP packet to an AGG according to a flooding algorithm; and finally, the AGG acquires the GM LSP packet sent by the access switch ACC.

Specifically, a method for acquiring, by the ACC, the GM LSP packet sent by the multicast group receiver is as follows:

An RB of a TRILL network edge enables an IGMP SNOOPING (Internet Group Management Protocol Snooping, Internet Group Management Protocol snooping) function, and periodically sends a query packet to the multicast group receiver, to trigger the multicast group receiver to send an IGMP Report (Internet Group Management Protocol Report, Internet Group Management Protocol report) packet.

When receiving port information of the IGMP Report packet by using the snooping function, the ACC needs to establish a multicast forwarding entry according to the port information of the packet, and implements on-demand replication of multicast traffic on a port side of a multicast group receiver. When receiving the IGMP Report packet, the ACC needs to notify the TRILL network of multicast group information in the IGMP Report packet, or multicast source information and multicast group information in the IGMP Report packet, performs pruning calculation according to the multicast group information, or the multicast source information and multicast group information, to implement on-demand replication of multicast traffic in the TRILL network.

302. Compare multicast join information in the GM LSP packet with multicast join information that is stored in the AGG and updated last time, to obtain a comparison result.

For example, step 302 may be implemented according to the following two methods:

A first method is as follows: when the multicast join information in the GM LSP packet includes a VLAN identifier and multicast group information corresponding to the VLAN identifier, classifying and combining, according to the VLAN identifier, the multicast join information that is stored in the AGG and updated last time, to obtain first multicast join information, where the first multicast join information is each VLAN identifier and multicast group information corresponding to each VLAN identifier that are stored in the AGG; classifying and combining, according to the VLAN identifier, the multicast join information in the GM LSP packet, to obtain second multicast join information, where the second multicast join information is each VLAN identifier and multicast group information corresponding to each VLAN identifier that are in the GM LSP packet; and comparing the first multicast join information with the second multicast join information to obtain the comparison result, where the comparison result includes: when the first multicast join information is compared with the second multicast join information, and there is newly added multicast group information in a specific VLAN of the second multicast join information, the comparison result includes the newly added multicast group information.

### Embodiment 1

For example, in the embodiment of the present invention, it is assumed that the multicast join information that is stored in the AGG and updated last time is a GM LSP packet 1 (VLAN1, Group1, Group2) advertised by an ACC1 and a GM LSP packet 2 (VLAN1, Group1, Group3) advertised by an ACC2, and the multicast join information in the GM LSP packet received by the AGG is a GM LSP packet 3 (VLAN1, Group2, Group4) advertised by an ACC3; and it should be noted that the multicast join information in the GM LSP packet received by the AGG may be one piece or may be multiple pieces. Multicast join information of the GM LSP packet 1, the GM LSP packet 2, and the GM LSP packet 3 includes a VLAN identifier and multicast group information corresponding to the VLAN identifier. First, the multicast join information that is stored in the AGG and updated last time is classified and combined according the VLAN identifier, that is, the multicast join information in the GM LSP packet 1 and the GM LSP packet 2 is classified and combined according the VLAN identifier; because VLAN identifiers in the GM LSP packet 1 and the GM LSP packet 2 are both VLAN1, the first multicast join information obtained after classification and combination is VLAN1 and multicast group information Group1, Group2, and Group3 corresponding to VLAN1 that are stored in the AGG. Then, the multicast join information in the received GM LSP packet 3 is classified and combined according to the VLAN identifier, to obtain the second multicast join information; because the VLAN identifier of the GM LSP packet 3 is also VLAN1, the second multicast join information, obtained after classification and combination, in the GM LSP packet 3 is VLAN1 and multicast group information Group2 and Group4 corresponding to VLAN1. Then, the first multicast join information is compared with the second multicast join information, and obviously, it may be obtained, by comparing, that there is newly added multicast group information Group4 in VLAN1 of the second multicast join information.

When the first multicast join information is compared with the second multicast join information, and there is reduced multicast group information in a specific VLAN of the second multicast join information, the comparison result includes the reduced multicast group information.

### Embodiment 2

For example, in the embodiment of the present invention, it is assumed that the multicast join information that is stored in the AGG and updated last time is a GM LSP packet 4 (VLAN1, Group1, Group2) advertised by an ACC1 and a GM LSP packet 5 (VLAN1, Group1, Group3) advertised by an ACC2, and the multicast join information in the GM LSP packet received by the AGG is a GM LSP packet 6 (VLAN1, Group1) advertised by the ACC2; and it should be noted that multicast join information of the GM LSP packet 4, the GM LSP packet 5, and the GM LSP packet 6 includes a VLAN identifier and multicast group information corresponding to the VLAN identifier. First, the multicast join information that is stored in the AGG and updated last time is classified and combined according the VLAN identifier, that is, the multicast join information in the GM LSP packet 4 and the GM LSP packet 5 is classified and combined according the VLAN identifier; because VLAN identifiers in the GM LSP packet 4 and the GM LSP packet 5 are both VLAN1, the first multicast join information obtained after classification and combination is VLAN1 and multicast group information Group1, Group2, and Group3 corresponding to VLAN1 that are stored in the AGG. Then, the multicast join information in the received GM LSP packet 6 is classified and combined according to the VLAN identifier, to obtain the second multicast join information; because the VLAN identifier of the GM LSP packet 6 is also VLAN1, the second multicast join information, obtained after classification and combination, in the GM LSP packet 6 is VLAN1 and multicast group information Group1 corresponding to VLAN1. Then, the first multicast join information is compared with the second multicast join information, and obviously, it may be obtained, by comparing, that there is reduced multicast group information Group2 and Group3 in VLAN1 of the second multicast join information.

A second method is as follows: when the multicast join information in the GM LSP packet includes a VLAN identifier and multicast source information and multicast group information that are corresponding to the VLAN identifier, classifying and combining, according to the VLAN identifier, the multicast join information that is stored in the AGG and updated last time, to obtain first multicast join information, where the first multicast join information is each VLAN identifier and multicast source information and multicast group information corresponding to each VLAN identifier that are stored in the AGG; classifying and combining, according to the VLAN identifier, the multicast join information in the GM LSP packet, to obtain second multicast join information, where the second multicast join information is each VLAN identifier and multicast source information and multicast group information corresponding to each VLAN identifier that are stored in the GM LSP packet; and comparing the first multicast join information with the second multicast join information to obtain the comparison result, where the comparison result includes: when the first multicast join information is compared with the second multicast join information, and there is newly added multicast source information and multicast group information in a specific VLAN of the second multicast join information, the comparison result includes the newly added multicast source information and multicast group information.

### Embodiment 3

For example, in the embodiment of the present invention, it is assumed that the multicast join information that is stored in the AGG and updated last time is a GM LSP packet 7 (VLAN1, S1, Group1) advertised by an ACC1, and multicast join information in a GM LSP packet 8 received by the AGG is the GM LSP packet 8 (VLAN1, S2, Group1) advertised by an ACC2 and a GM LSP packet 9 (VLAN1, S1, Group1) advertised by an ACC3; and it should be noted that multicast join information of the GM LSP packet 7, the GM LSP packet 8, and the GM LSP packet 9 includes a VLAN identifier and multicast source information and multicast group information corresponding to the VLAN identifier. First, the multicast join information that is stored in the AGG and updated last time is classified and combined according the VLAN identifier; because the VLAN identifier in the GM LSP packet 7 is VLAN1, the first multicast join information obtained after classification and combination is VLAN1 and multicast source information and multicast group information (S1, Group1) corresponding to VLAN1 that are stored in the AGG. Then, the multicast join information in the received GM LSP packet 8 and GM LSP packet 9 is classified and combined according to the VLAN identifier, to obtain the second multicast join information; because VLAN identifiers of the GM LSP packet 8 and the GM LSP packet 9 are both VLAN1, the second multicast join information, obtained after classification and combination, is VLAN1 and multicast source information and multicast group information (S2, Group1) and (S1, Group1) corresponding to VLAN1. Then, the first multicast join information is compared with the second multicast join information, and obviously, it may be obtained, by comparing, that there is newly added multicast source information and multicast group information (S2, Group1) in VLAN1 of the second multicast join information.

When the first multicast join information is compared with the second multicast join information, and there is reduced multicast source information and multicast group information in a specific VLAN of the second multicast join information, the comparison result includes the reduced multicast source information and multicast group information.

### Embodiment 4

For example, in the embodiment of the present invention, it is assumed that the multicast join information that is stored in the AGG and updated last time is a GM LSP packet 10 (VLAN1, S1, Group1) advertised by an ACC1 and a GM LSP packet 11 (VLAN1, S2, Group1) advertised by an ACC2, and multicast join information in a GM LSP packet 12 that is received by the AGG and advertised by an ACC3 is (VLAN1, S2, Group1); and it should be noted multicast join information of the GM LSP packet 10 and the GM LSP packet 11 includes a VLAN identifier and multicast source information and multicast group information corresponding to the VLAN identifier. First, the multicast join information that is stored in the AGG and updated last time is classified and combined according the VLAN identifier; because VLAN identifiers in the GM LSP packet 10 and the GM LSP packet 11 are VLAN1, the first multicast join information obtained after classification and combination is VLAN1 and multicast source information and multicast group information (S1, Group1) and (S2, Group2) corresponding to VLAN1 that are stored in the AGG. Then, the multicast join information in the received GM LSP packet 12 is classified and combined according to the VLAN identifier, to obtain the second multicast join information; because the VLAN identifier of the GM LSP packet 12 is VLAN1, the second multicast join information, obtained after classification and combination, in the GM LSP packet 12 is VLAN1 and multicast source information and multicast group information (S2, Group1) corresponding to VLAN1. Then, the first multicast join information is compared with the second multicast join information, and obviously, it may be obtained, by comparing, that there is reduced multicast source information and multicast group information (S1, Group1) in VLAN1 of the second multicast join information.

It should be noted that the multicast join information in the GM LSP packet received by the AGG may be one piece or may be multiple pieces; therefore, the multicast join information in the GM LSP packet is compared with the multicast join information that is stored in the AGG and updated last time, and there may be newly added multicast join information and reduced multicast join information in the obtained comparison result at the same time. For example, it is assumed that the multicast join information that is stored in the AGG and updated last time is a GM LSP packet 13 (VLAN1, Group1, Group2) advertised by the ACC1 and a GM LSP packet 14 (VLAN2, Group3, Group4) advertised by the ACC2, a GM LSP packet 15 that is received by the AGG and advertised by the ACC3 is (VLAN1, Group2, Group5), and a GM LSP packet 16 that is received by the AGG and advertised by the ACC2 is (VLAN2, Group4); the multicast join information that is stored in the AGG and updated last time is classified and combined according to the VLAN identifier, and the obtained first multicast join information is (VLAN1, Group1, Group2) and (VLAN2, Group3, Group4); the multicast join information in the GM LSP packet received by the AGG is classified and combined according to the VLAN identifier, and the obtained second multicast join information is (VLAN1, Group2, Group5) and (VLAN2, Group4); and then the first multicast join information is compared with the second multicast join information, and obviously, the comparison result may be obtained, by comparing, that there is newly added multicast group information Group5 and reduced multicast group information Group1 in VLAN1 of the second multicast join information, and there is reduced multicast group information Group3 in VLAN2. Then, step 303 is executed, a preset-protocol packet is generated according to the comparison result and according to a preset format.

303. Update, according to the comparison result, the multicast join information stored in the AGG.

Step 303 specifically includes the following: the AGG updates, by using the comparison result obtained in step 302, the multicast join information that is stored in the AGG and updated last time, adds the newly added multicast group information, or multicast source information and multicast group information into the multicast join information that is stored in the AGG and updated last time, and deletes the reduced multicast group information, or multicast source information and multicast group information from the multicast join information that is stored in the AGG and updated last time, to obtain latest multicast join information stored in the AGG.

For example, the multicast join information stored in the AGG may be updated according to Embodiment 2, to obtain new multicast join information (VLAN1, Group1) stored in the AGG; and the multicast join information stored in the AGG may be updated according to Embodiment 4, to obtain new multicast join information (VLAN1, S2, Group1) stored in the AGG.

304. When there is changed multicast join information in the comparison result, generate, according to the comparison result, a preset-protocol packet according to a preset format, where the preset-protocol packet is an IGMP packet or a PIM packet.

When the IGMP protocol runs between the AGG and a first multicast router, step 304 specifically includes the following: the AGG generates, according to the comparison result, an IGMP packet according to the preset format, where the preset format includes: a V1 format, a V2 format, or a V3 format, where V1, V2, and V3 are version numbers of the IGMP protocol.

When the preset format is the V1 format or the V2 format, and when there is the newly added multicast group information in the comparison result, the generating, according to the comparison result, an IGMP packet according to the preset format includes the following: the AGG generates a first IGMP report packet according to the newly added multicast join information in the comparison result, where the first IGMP report packet is generated according to the newly added multicast group information.

For example, for the newly added multicast group information Group4 of VLAN1 in Embodiment 1 of the present invention, when the version number of the IGMP protocol is V1 or V2, the AGG generates, according to the comparison result, the first IGMP report packet according to the preset format, which is the V1 format or the V2 format, where the first IGMP report packet may be an IGMP Report packet, and the first IGMP report packet includes the newly added multicast group information, that is, the newly added multicast group information Group4 in VLAN1.

When the preset format is the V3 format, and when there is the newly added multicast group information in the comparison result, or there is the newly added multicast source information and multicast group information in the comparison result, the generating, according to the comparison result, an IGMP packet according to the preset format includes the following: the AGG generates an allow packet according to the newly added multicast join information in the comparison result, where the allow packet is generated according to the newly added multicast group information or according to the newly added multicast source information and multicast group information.

For example, for the newly added multicast group information Group4 of VLAN1 in Embodiment 1, when the version number of the IGMP protocol is V3, the AGG generates an allow packet according to the newly added multicast join information in the comparison result, for example, the allow packet may be TO_IN(NULL, Group4), and the allow packet indicates that the multicast group information Group4 is added in VLAN1. For the newly added multicast source information and multicast group information (S2, Group1) in VLAN1 in Embodiment 3, the AGG generates an allow packet according to the newly added multicast join information in the comparison result, for example, the allow packet may be ALLOW(S2, Group1), and the allow packet indicates that the multicast source information and multicast group information (S2, Group1) are added in VLAN1.

When the preset format is the V3 format, and when there is the reduced multicast group information in the comparison result, or there is the reduced multicast source information and multicast group information in the comparison result, the generating, according to the comparison result, an IGMP packet according to the preset format includes the following: the AGG generates a leave packet according to the reduced multicast join information in the comparison result, where the leave packet is generated according to the reduced multicast group information or according to the reduced multicast source information and multicast group information.

For example, for the reduced multicast group information Group2 and Group3 in VLAN1 in Embodiment 2, when the version number of the IGMP protocol is V3, the AGG generates a leave packet according to the reduced multicast join information in the comparison result, for example, the leave packet may be TO_EX(NULL, Group2) and TO_EX(NULL, Group3), and the leave packet indicates that the multicast group information Group2 and Group3 is reduced in VLAN1. For the reduced multicast source information and multicast group information (S1, Group1) in VLAN1 in Embodiment 4, the AGG generates a leave packet according to the reduced multicast join information in the comparison result, for example, the leave packet may be BLOCK(S1, Group1), and the leave packet indicates that the multicast source information and multicast group information (S1, Group1) are reduced in VLAN1.

When the preset format is the V1 format or the V2 format, and when there is the reduced multicast group information in the comparison result, the generating, according to the comparison result, an IGMP packet according to the preset format includes the following: the AGG generates a leave indication packet according to the reduced multicast join information in the comparison result, where the leave indication packet is generated according to the reduced multicast group information. It should be noted that this method is appropriate for a case in which the preset format is the V2 format and the first multicast router has an IGMP fast-leave function.

For example, for the reduced multicast group information Group2 and Group3 in VLAN1 in Embodiment 2 of the present invention, when the version number of the IGMP protocol is V1, or when the version number of the IGMP protocol is V2 and the first multicast router has the IGMP fast-leave (IGMP Fast Leave, IGMP fast-leave) function, the AGG generates a leave indication packet according to the reduced multicast join information in the comparison result, where the leave indication packet may be an IGMP leave packet, and the leave indication packet is generated according to the reduced multicast group information Group2 and Group3 in VLAN1.

Optionally, when the preset format is the V2 format, or when the preset format is the V3 format, the generating, according to the comparison result, an IGMP packet according to the preset format further includes the following: the AGG receives a group-specific query packet sent by the first multicast router, where the group-specific query packet includes a specific VLAN identifier; and the AGG generates a second IGMP report packet according to the comparison result, where the second IGMP report packet is generated according to the updated multicast join information that is stored in the AGG and updated last time.

For example, for the reduced multicast group information Group2 and Group3 in VLAN1 in Embodiment 2 of the present invention, when the version number of the IGMP protocol is V2, the AGG receives the group-specific query packet sent by the first multicast router, where the group-specific query packet includes a specific VLAN identifier, namely, VLAN1. After receiving the group-specific query packet, the AGG sends to the first multicast router the multicast group information that is corresponding to VLAN1, stored in the AGG, and obtained by updating in step 303, which is (VLAN1, Group1). For the reduced multicast source information and multicast group information (VLAN1, S1, Group1) in VLAN1 in Embodiment 4 of the present invention, when the version number of the IGMP protocol is V3, the AGG receives the group-specific query packet sent by the first multicast router, where the group-specific query packet includes a specific VLAN identifier, namely, VLAN1. After receiving the group-specific query packet, the AGG sends to the first multicast router the multicast source information and multicast group information that are corresponding to VLAN1, stored in the AGG, and obtained by updating in step 303, which are (VLAN1, S2, Group1).

Optionally, when the version number of the IGMP protocol is V1, for the reduced multicast group information Group2 and Group3 in VLAN1 in Embodiment 2, the AGG may also not perform any actions. Because a timer is disposed in the first multicast router, when the first multicast router does not receive the multicast group information Group2 or Group3 corresponding to VLAN1 within time specified by the timer, it is considered that a receiver of the multicast group information Group2 and Group3 corresponding to VLAN1 gives up receiving of the multicast group information Group 2 and Group3; and then, the AGG removes the multicast group information Group2 and Group3 corresponding to VLAN1 from an outbound port of a corresponding multicast forwarding entry.

Further, when the PIM protocol runs between the AGG and the first multicast router, step 304 specifically includes the following: when there is the newly added multicast group information in the comparison result, the generating, according to the comparison result, a preset-protocol packet according to a preset format includes the following: the AGG generates a PIM SM Join according to the newly added multicast join information in the comparison result, where the PIM SM Join is generated according to the newly added multicast group information.

For example, for the newly added multicast group information Group4 in VLAN1 in Embodiment 1 of the present invention, the AGG generates the PIM SM Join. The PIM SM Join is generated according to the newly added multicast group information, namely, the multicast group information Group4 in VLAN1.

When there is the newly added multicast source information and multicast group information in the comparison result, the generating, according to the comparison result, a preset-protocol packet according to a preset format includes the following: the AGG generates the PIM SSM Join according to the newly added multicast join information in the comparison result, where the PIM SSM Join is generated according to the newly added multicast source information and multicast group information.

For example, for the newly added multicast source information and multicast group information (S2, Group1) in VLAN1 in Embodiment 3 of the present invention, the AGG generates the PIM SSM Join, where the PIM SSM Join is generated according to the newly added multicast source information and multicast group information (S2, Group1) in VLAN1.

When there is the reduced multicast group information in the comparison result, the generating, according to the comparison result, a preset-protocol packet according to a preset format includes the following: the AGG generates a PIM SM Prune according to the reduced multicast join information in the comparison result, where the PIM SM Prune is used to delete the reduced multicast group information.

For example, for the reduced multicast group information Group2 and Group3 in VLAN1 in Embodiment 2 of the present invention, the AGG generates the PIM SM Prune. The PIM SM Prune is generated according to the reduced multicast group information in VLAN1, namely, the reduced multicast group information Group2 and Group3 in VLAN1.

When there is the reduced multicast source information and multicast group information in the comparison result, the generating, according to the comparison result, a preset-protocol packet according to a preset format includes the following: the AGG generates the PIM SSM Prune according to the reduced multicast join information in the comparison result, where the PIM SSM Prune is used to delete the reduced multicast source information and multicast group information.

For the reduced multicast source information and multicast group information (S1, Group1) in VLAN1 in Embodiment 4, the AGG generates the PIM SSM Prune according to the reduced multicast join information in the comparison result, where the PIM SSM Prune is generated according to the reduced multicast source information and multicast group information (S1, Group1) in VLAN1.

305. Send the preset-protocol packet to a first multicast router, so that the first multicast router generates a multicast forwarding entry according to the preset-protocol packet.

When there is changed multicast join information in the specific VLAN identifier, the AGG sends, in a VLAN indicated by the specific VLAN identifier, the preset-protocol packet to the first multicast router, and updates the multicast forwarding entry by using the preset-protocol packet, where the multicast forwarding entry includes a multicast group address and an outbound port, and is used to perform multicast replication.

For example, for the reduced multicast source information and multicast group information (S1, Group1) in VLAN1 in Embodiment 4, the AGG generates the PIM SSM Prune according to the reduced multicast source information and multicast group information (S1, Group1) in VLAN1, and sends, in a channel of VLAN1, the PIM SSM Prune to the first multicast router; and then the first multicast router updates the multicast forwarding entry by using the PIM SSM Prune, and removes an outbound port of the reduced multicast source information and multicast group information (S1, Group1) from the multicast forwarding entry.

The embodiment of the present invention provides a multicast communications method, where: the acquired GM LSP packet is compared with the GM LSP packet stored in the AGG; and when there is changed multicast join information in the comparison result, a preset-protocol packet is generated according to the comparison result, and the preset-protocol packet is sent to the first multicast router, where the comparison result includes newly added or reduced multicast group information, or includes newly added or reduced multicast source information and multicast group information. Compared with the prior art, the newly added or reduced multicast group information, or the newly added or reduced multicast source information and multicast group information is actively sent to the first multicast router, which implements on-demand sending on a path from the AGG to the first multicast router, thereby saving link bandwidth from the AGG to the first multicast router.

It should be noted that, in the multicast communications in the IPTV scenario, the method further includes: receiving, by a first multicast router, a preset-protocol packet sent by the AGG, where the first multicast router is a router connected to the AGG, the preset-protocol packet is an IGMP packet or a PIM packet, and the preset-protocol packet is generated by the AGG according to packet content of the GM LSP packet; and the first multicast router sends the preset-protocol packet to a last-hop multicast router. It should be noted that, the first multicast router forwards the preset-protocol packet to the last-hop multicast router according to a multicast forwarding entry. A specific forwarding process is the same as that in the prior art, which is not further described herein in the present invention.

When the packet is sent to the last-hop multicast router, the last-hop multicast router performs election. Specifically, when the IGMP protocol runs between the AGG and the last-hop multicast router, after receiving the IGMP Report sent by the first multicast router, the last-hop multicast router starts to perform IGMP router election; for example, assuming that the last-hop multicast router includes a router 1 and a router 2, and after election, the router 2 is a non-querier and the router 1 is a querier, in the following, only the router 1 needs to send the IGMP Report to the AGG, and only the router 1 is responsible for sending a data stream of a multicast source to a multicast receiver. When the PIM protocol runs between the AGG and the last-hop multicast router, after the last-hop multicast router receives the PIM SM Join or PIM SSM Join message sent by the first multicast router, a PIM hello packet is mutually sent between last-hop multicast routers, to elect a DR (Designated Router, designated router) and a BDR (Backup Designated Router, backup designated router). For example, assuming that the last-hop multicast router includes a router 1 and a router 2, and after election, the router 2 is a BDR and the router 1 is a DR, in the following, only the router 1 needs to be responsible for sending a data stream of a multicast source to a multicast receiver. It should be noted that a method of router election is the same as that in the prior art, which is not further described herein in the present invention.

In particular, after receiving a data stream of a multicast source sent by the multicast source, the querier router 1 or DR router 1 queries the multicast forwarding entry, and if an outbound interface of the multicast forwarding entry includes an outbound port connected to the TRILL network, the data stream of the multicast source is replicated and forwarded; after receiving the data stream of the multicast source from the first multicast router, the AGG forwards, by using a distribution tree entry pruned by the TRILL network, the data stream of the multicast source to the TRILL network; after receiving a data stream of a multicast source sent by a TRILL network side, the ACC device first decapsulates the data stream of the multicast source to recover the data stream to a data stream of a multicast source of a Native ETH (Native EtherNet, native Ethernet), then queries a local IGMP Snooping multicast forwarding table, and replicates and forwards the data stream of the multicast source according to the IGMP Snooping multicast forwarding table until the data stream of the multicast source is forwarded to a receiver of the multicast group information.

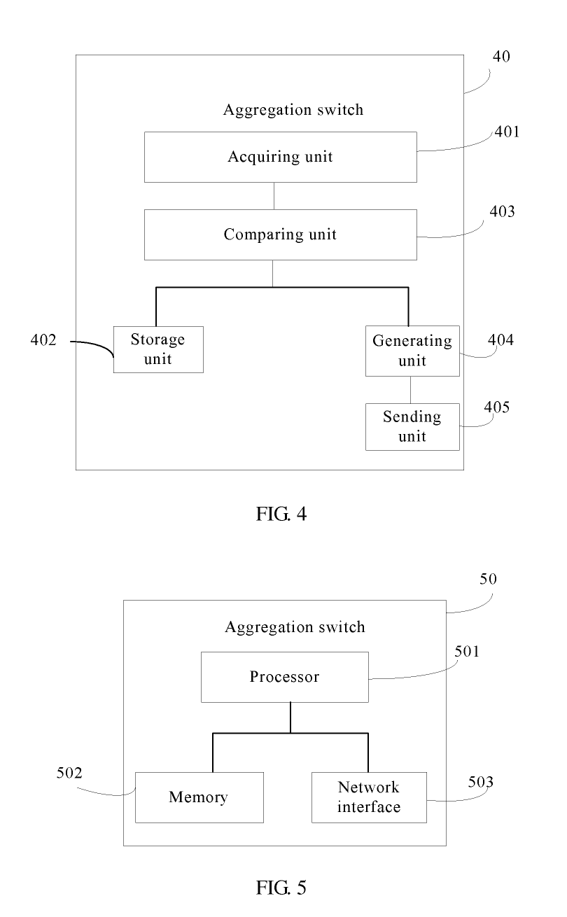

An embodiment of the present invention provides an AGG 40. As shown in FIG. 4, the AGG 40 includes:

an acquiring unit 401, configured to acquire a GM LSP packet sent by an ACC;

a storage unit 402, configured to store multicast join information that is updated last time;

a comparing unit 403, configured to: compare multicast join information in the GM LSP packet acquired by the acquiring unit with the multicast join information in the storage unit, to obtain a comparison result, send the comparison result to a generating unit, and update the multicast join information in the storage unit according to the comparison result;

a generating unit 404, configured to: receive the comparison result sent by the comparing unit, and when there is changed multicast join information in the comparison result, generate, according to the comparison result, a preset-protocol packet according to a preset format, where the preset-protocol packet is an IGMP packet or a PIM packet; and

a sending unit 405, configured to send the preset-protocol packet generated by the generating unit to a first multicast router, so that the first multicast router generates a multicast forwarding entry according to the preset-protocol packet.

In this way, the acquiring unit acquires the GM LSP packet; the comparing unit compares the GM LSP packet with the GM LSP packet stored in the storage unit; the generating unit generates, according to the comparison result, the preset-protocol packet by using a packet that needs to be sent; and the sending unit sends the preset-protocol packet to the first multicast router, where the comparison result includes newly added or reduced multicast group information, or includes newly added or reduced multicast source information and multicast group information. Compared with the prior art, the newly added or reduced multicast group information, or the newly added or reduced multicast source information and multicast group information is actively sent to the first multicast router, which implements on-demand sending on a path from the AGG to the first multicast router, thereby saving link bandwidth from the AGG to the first multicast router.

The GM LSP packet is a TRILL LSP packet; and the multicast join information in the GM LSP packet includes: a VLAN identifier and multicast group information corresponding to the VLAN identifier, or the multicast join information in the GM LSP packet includes: a VLAN identifier and multicast source information and multicast group information that are corresponding to the VLAN identifier.

Optionally, the comparing unit 403 is specifically configured to:

when the multicast join information in the GM LSP packet includes a VLAN identifier and multicast group information corresponding to the VLAN identifier, classify and combine, according to the VLAN identifier, the multicast join information stored in the storage unit 402, to obtain first multicast join information, where the first multicast join information is each VLAN identifier and multicast group information corresponding to each VLAN identifier that are stored in the AGG; classify and combine, according to the VLAN identifier, the multicast join information in the GM LSP packet acquired by the acquiring unit 401, to obtain second multicast join information, where the second multicast join information is each VLAN identifier and multicast group information corresponding to each VLAN identifier that are in the GM LSP packet; and compare the first multicast join information with the second multicast join information to obtain the comparison result, where the comparison result includes: when the first multicast join information is compared with the second multicast join information, and there is newly added multicast group information in a specific VLAN of the second multicast join information, the comparison result includes the newly added multicast group information; and when the first multicast join information is compared with the second multicast join information, and there is reduced multicast group information in a specific VLAN of the second multicast join information, the comparison result includes the reduced multicast group information; or

when the multicast join information in the GM LSP packet includes a VLAN identifier and multicast source information and multicast group information that are corresponding to the VLAN identifier, classify and combine, according to the VLAN identifier, the multicast join information stored in the storage unit 402, to obtain first multicast join information, where the first multicast join information is each VLAN identifier and multicast source information and multicast group information corresponding to each VLAN identifier that are stored in the AGG; classify and combine, according to the VLAN identifier, the multicast join information in the GM LSP packet acquired by the acquiring unit 401, to obtain second multicast join information, where the second multicast join information is each VLAN identifier and multicast source information and multicast group information corresponding to each VLAN identifier that are stored in the GM LSP packet; and compare the first multicast join information with the second multicast join information to obtain the comparison result, where the comparison result includes: when the first multicast join information is compared with the second multicast join information, and there is newly added multicast source information and multicast group information in a specific VLAN of the second multicast join information, the comparison result includes the newly added multicast source information and multicast group information; and when the first multicast join information is compared with the second multicast join information, and there is reduced multicast source information and multicast group information in a specific VLAN of the second multicast join information, the comparison result includes the reduced multicast source information and multicast group information.

Optionally, when the preset-protocol packet is an IGMP packet, the generating unit 404 is specifically configured to:

receive the comparison result sent by the comparing unit 403, and generate, according to the comparison result, an IGMP packet according to the preset format, where the preset format includes: a V1 format, a V2 format, or a V3 format, where V1, V2, and V3 are version numbers of the IGMP protocol.

Optionally, when the preset format is the V1 format or the V2 format, and there is the newly added multicast group information in the comparison result, the generating unit 404 is specifically configured to:

receive the comparison result sent by the comparing unit 403, and generate a first IGMP report packet according to the newly added multicast join information in the comparison result, where the first IGMP report packet is generated according to the newly added multicast group information.

When the preset format is the V3 format, and when there is the newly added multicast group information in the comparison result, or there is the newly added multicast source information and multicast group information in the comparison result, the generating unit 404 is specifically configured to:

receive the comparison result sent by the comparing unit 403, and generate an allow packet according to the newly added multicast join information in the comparison result, where the allow packet is generated according to the newly added multicast group information or according to the newly added multicast source information and multicast group information.

Optionally, when the preset format is the V1 format or the V2 format, and when there is the reduced multicast group information in the comparison result, the generating unit 404 is specifically configured to:

receive the comparison result sent by the comparing unit 403, and generate a leave indication packet according to the reduced multicast join information in the comparison result, where the leave indication packet is generated according to the reduced multicast group information.

When the preset format is the V3 format, and when there is the reduced multicast group information in the comparison result, or there is the reduced multicast source information and multicast group information in the comparison result, the generating unit 404 is specifically configured to:

receive the comparison result sent by the comparing unit 403, and generate a leave packet according to the reduced multicast join information in the comparison result, where the leave packet is generated according to the reduced multicast group information or according to the reduced multicast source information and multicast group information.

When the preset format is the V2 format, or when the preset format is the V3 format, the generating unit 404 is specifically configured to:

receive a group-specific query packet sent by the first multicast router, where the group-specific query packet includes a specific VLAN identifier; and generate a second IGMP report packet according to the comparison result, where the second IGMP report packet is generated according to the updated multicast join information.

When the preset-protocol packet is a PIM packet,

when there is the newly added multicast group information in the comparison result, the generating unit 404 is specifically configured to:

receive the comparison result of the comparing unit 403, and generate a PIM SM Join according to the newly added multicast join information in the comparison result, where the PIM SM Join is generated according to the newly added multicast group information; and

when there is the newly added multicast source information and multicast group information in the comparison result, the generating unit 404 is specifically configured to:

receive the comparison result of the comparing unit 403, and generate a PIM SSM Join according to the newly added multicast join information in the comparison result, where the PIM SSM Join is generated according to the newly added multicast source information and multicast group information.

When there is the reduced multicast group information in the comparison result, the generating unit 404 is specifically configured to:

receive the comparison result of the comparing unit, and generate a PIM SM Prune according to the reduced multicast join information in the comparison result, where the PIM SM Prune is used to delete the reduced multicast group information.

When there is the reduced multicast source information and multicast group information in the comparison result, the generating unit 404 is specifically configured to:

receive the comparison result of the comparing unit, and generate the PIM SSM Prune according to the reduced multicast join information in the comparison result, where the PIM SSM Prune message is used to delete the reduced multicast source information and multicast group information.

The embodiment of the present invention provides an AGG, where the acquiring unit acquires the GM LSP packet; the comparing unit compares the GM LSP packet with the GM LSP packet stored in the storage unit; the generating unit generates, according to the comparison result, the preset-protocol packet by using a packet that needs to be sent; and the sending unit sends the preset-protocol packet to the first multicast router, where the comparison result includes newly added or reduced multicast group information, or includes newly added or reduced multicast source information and multicast group information. Compared with the prior art, the newly added or reduced multicast group information, or the newly added or reduced multicast source information and multicast group information is actively sent to the first multicast router, which implements on-demand sending on a path from the AGG to the first multicast router, thereby saving link bandwidth from the AGG to the first multicast router.

An embodiment of the present invention provides a communications system, including an ACC and any AGG provided in the embodiments of the present invention.

An embodiment of the present invention provides another AGG. As shown in FIG. 5, the AGG includes:

a processor 501, a memory 502, and a network interface 503, where the network interface 501 is configured to acquire a GM LSP packet sent by an ACC; the memory 502 is configured to: store multicast join information that is updated last time, and store an instruction; the processor 501 is configured to execute the instruction and is configured to: compare multicast join information in the GM LSP packet with the multicast join information in the memory, to obtain a comparison result, and update the multicast join information in the memory according to the comparison result; the processor 501 is further configured to execute the instruction and is configured to: when there is changed multicast join information in the comparison result, generate, according to the comparison result, a preset-protocol packet according to a preset format, where the preset-protocol packet is an IGMP packet or a PIM packet; and the network interface 503 is further configured to send the generated preset-protocol packet to a first multicast router, so that the first multicast router generates a multicast forwarding entry according to the preset-protocol packet.

In this way, the processor acquires the GM LSP packet, compares the GM LSP packet with the GM LSP packet stored in the memory, and generates, according to the comparison result, the preset-protocol packet by using a packet that needs to be sent; then the network interface sends the preset-protocol packet to the first multicast router, where the comparison result includes newly added or reduced multicast group information, or includes newly added or reduced multicast source information and multicast group information. Compared with the prior art, the newly added or reduced multicast group information, or the newly added or reduced multicast source information and multicast group information is actively sent to the first multicast router, which implements on-demand sending on a path from the AGG to the first multicast router, thereby saving link bandwidth from the AGG to the first multicast router.

The GM LSP packet is a TRILL LSP packet; and the multicast join information in the GM LSP packet includes: a VLAN identifier and multicast group information corresponding to the VLAN identifier, or the multicast join information in the GM LSP packet includes: a VLAN identifier and multicast source information and multicast group information that are corresponding to the VLAN identifier.

Optionally, that the processor 501 executes the instruction and is configured to compare multicast join information in the GM LSP packet with multicast join information that is stored in the AGG and updated last time, to obtain a comparison result includes:

when the multicast join information in the GM LSP packet includes a VLAN identifier and multicast group information corresponding to the VLAN identifier, classifying and combining, according to the VLAN identifier, the multicast join information stored in the memory 502, to obtain first multicast join information, where the first multicast join information is each VLAN identifier and multicast group information corresponding to each VLAN identifier that are stored in the AGG; classifying and combining, according to the VLAN identifier, the multicast join information in the GM LSP packet acquired by the processor 501, to obtain second multicast join information, where the second multicast join information is each VLAN identifier and multicast group information corresponding to each VLAN identifier that are in the GM LSP packet; and comparing the first multicast join information with the second multicast join information to obtain the comparison result, where the comparison result includes: when the first multicast join information is compared with the second multicast join information, and there is newly added multicast group information in a specific VLAN of the second multicast join information, the comparison result includes the newly added multicast group information; and when the first multicast join information is compared with the second multicast join information, and there is reduced multicast group information in a specific VLAN of the second multicast join information, the comparison result includes the reduced multicast group information; or

when the multicast join information in the GM LSP packet includes a VLAN identifier and multicast source information and multicast group information that are corresponding to the VLAN identifier, classifying and combining, according to the VLAN identifier, the multicast join information stored in the memory 502, to obtain first multicast join information, where the first multicast join information is each VLAN identifier and multicast source information and multicast group information corresponding to each VLAN identifier that are stored in the AGG; classifying and combining, according to the VLAN identifier, the multicast join information in the GM LSP packet acquired by the processor 501, to obtain second multicast join information, where the second multicast join information is each VLAN identifier and multicast source information and multicast group information corresponding to each VLAN identifier that are stored in the GM LSP packet; and comparing the first multicast join information with the second multicast join information to obtain the comparison result, where the comparison result includes: when the first multicast join information is compared with the second multicast join information, and there is newly added multicast source information and multicast group information in a specific VLAN of the second multicast join information, the comparison result includes the newly added multicast source information and multicast group information; and when the first multicast join information is compared with the second multicast join information, and there is reduced multicast source information and multicast group information in a specific VLAN of the second multicast join information, the comparison result includes the reduced multicast source information and multicast group information.

Optionally, when the preset-protocol packet is an IGMP packet, that the processor 501 executes the instruction and is configured to generate, according to the comparison result, a preset-protocol packet according to a preset format includes:

generating, according to the comparison result, an IGMP packet according to the preset format, where the preset format includes: a V1 format, a V2 format, or a V3 format, where V1, V2, and V3 are version numbers of the IGMP protocol.

Optionally, when the preset format is the V1 format or the V2 format, and there is the newly added multicast group information in the comparison result, that the processor 501 executes the instruction and is configured to generate, according to the comparison result, an IGMP packet according to the preset format includes:

generating a first IGMP report packet according to the newly added multicast join information in the comparison result, where the first IGMP report packet is generated according to the newly added multicast group information.

When the preset format is the V3 format, and when there is the newly added multicast group information in the comparison result, or there is the newly added multicast source information and multicast group information in the comparison result, that the processor 501 executes the instruction and is configured to generate, according to the comparison result, an IGMP packet according to the preset format includes:

generating an allow packet according to the newly added multicast join information in the comparison result, where the allow packet is generated according to the newly added multicast group information or according to the newly added multicast source information and multicast group information.

When the preset format is the V1 format or the V2 format, and when there is the reduced multicast group information in the comparison result, that the processor 501 executes the instruction and is configured to generate, according to the comparison result, an IGMP packet according to the preset format includes:

generating a leave indication packet according to the reduced multicast join information in the comparison result, where the leave indication packet is generated according to the reduced multicast group information.

When the preset format is the V3 format, and when there is the reduced multicast group information in the comparison result, or there is the reduced multicast source information and multicast group information in the comparison result, that the processor 501 executes the instruction and is configured to generate, according to the comparison result, an IGMP packet according to the preset format includes:

generating a leave packet according to the reduced multicast join information in the comparison result, where the leave packet is generated according to the reduced multicast group information or according to the reduced multicast source information and multicast group information.

Optionally, when the preset format is the V2 format, or when the preset format is the V3 format, that the processor 501 executes the instruction and is configured to generate, according to the comparison result, an IGMP packet according to the preset format includes:

receiving a group-specific query packet sent by the first multicast router, where the group-specific query packet includes a specific VLAN identifier; and generating a second IGMP report packet according to the comparison result, where the second IGMP report packet is generated according to the updated multicast join information that is stored in the AGG and updated last time.

Optionally, when the preset-protocol packet is a PIM packet, and there is the newly added multicast group information in the comparison result, that the processor 501 executes the instruction and is configured to generate, according to the comparison result, a preset-protocol packet according to a preset format includes:

generating a PIM SM Join according to the newly added multicast join information in the comparison result, where the PIM SM Join is generated according to the newly added multicast group information.

When there is the newly added multicast source information and multicast group information in the comparison result, that the processor 501 executes the instruction and is configured to generate, according to the comparison result, a preset-protocol packet according to a preset format includes:

generating a PIM SSM Join according to the newly added multicast join information in the comparison result, where the PIM SSM Join is generated according to the added multicast source information and multicast group information.

When there is the reduced multicast group information in the comparison result, that the processor 501 executes the instruction and is configured to generate, according to the comparison result, a preset-protocol packet according to a preset format includes:

generating a PIM SM Prune according to the reduced multicast join information in the comparison result, where the PIM SM Prune is used to delete the reduced multicast group information.

When there is the reduced multicast source information and multicast group information in the comparison result, that the processor 501 executes the instruction and is configured to generate, according to the comparison result, a preset-protocol packet according to a preset format includes:

generating the PIM SSM Prune according to the reduced multicast join information in the comparison result, where the PIM SSM Prune is used to delete the reduced multicast source information and multicast group information.

It may be clearly understood by a person skilled in the art that, for the purpose of convenient and brief description, for a specific step of the method described above, reference may be made to a corresponding process in the foregoing aggregation switch embodiments, and details are not described herein again.

It should be noted that, in the network encoding method provided in the embodiments of the present invention, a sequence of steps may be adjusted appropriately, and a step may also be added or removed based on circumstances. Any variation readily figured out by a person skilled in the art within the technical scope disclosed in the present invention shall fall within the protection scope of the present invention, which is not further described herein.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of hardware in addition to a software functional unit.

What is claimed is:

1. A multicast communications method, applied to an aggregation switch (AGG) and comprising:
acquiring a multicast group address link state protocol data unit (GM LSP) packet sent by an access switch (ACC);
comparing multicast join information in the GM LSP packet with multicast join information that is stored in the AGG and updated last time, to obtain a comparison result, and updating, according to the comparison result, the multicast join information stored in the AGG;
when there is changed multicast join information in the comparison result, generating, according to the comparison result, a preset-protocol packet according to a preset format, wherein the preset-protocol packet is an Internet Group Management Protocol (IGMP) packet or a Protocol Independent Multicast (PIM) packet; and
sending the preset-protocol packet to a first multicast router, so that the first multicast router generates a multicast forwarding entry according to the preset-protocol packet.

2. The method according to claim 1, wherein
the GM LSP packet is a Transparent Interconnection of Lots of Links (TRILL) LSP packet; and the multicast join information in the GM LSP packet comprises: a virtual local area network (VLAN) identifier and multicast group information corresponding to the VLAN identifier, or the multicast join information in the GM LSP packet comprises: a VLAN identifier and multicast source information and multicast group information that are corresponding to the VLAN identifier.

3. The method according to claim 1, wherein the comparing multicast join information in the GM LSP packet with multicast join information that is stored in the AGG and updated last time, to obtain a comparison result comprises:
when the multicast join information in the GM LSP packet comprises a VLAN identifier and multicast group information corresponding to the VLAN identifier,
classifying and combining, according to the VLAN identifier, the multicast join information that is stored in the AGG and updated last time, to obtain first multicast join information, wherein the first multicast join information is each VLAN identifier and multicast group information corresponding to each VLAN identifier that are stored in the AGG;
classifying and combining, according to the VLAN identifier, the multicast join information in the GM LSP packet, to obtain second multicast join information, wherein the second multicast join information is each VLAN identifier and multicast group information corresponding to each VLAN identifier that are in the GM LSP packet; and
comparing the first multicast join information with the second multicast join information to obtain the comparison result, wherein the comparison result comprises:
when the first multicast join information is compared with the second multicast join information, and there is newly added multicast group information in a specific VLAN of the second multicast join information, the comparison result comprises the newly added multicast group information; and
when the first multicast join information is compared with the second multicast join information, and there is reduced multicast group information in a specific VLAN of the second multicast join information, the comparison result comprises the reduced multicast group information; or
when the multicast join information in the GM LSP packet comprises a VLAN identifier and multicast source information and multicast group information that are corresponding to the VLAN identifier,
classifying and combining, according to the VLAN identifier, the multicast join information that is stored in the AGG and updated last time, to obtain first multicast join information, wherein the first multicast join information is each VLAN identifier and multicast source information and multicast group information corresponding to each VLAN identifier that are stored in the AGG;
classifying and combining, according to the VLAN identifier, the multicast join information in the GM LSP packet, to obtain second multicast join information, wherein the second multicast join information is each VLAN identifier and multicast source information and multicast group information corresponding to each VLAN identifier that are stored in the GM LSP packet; and
comparing the first multicast join information with the second multicast join information to obtain the comparison result, wherein the comparison result comprises:
when the first multicast join information is compared with the second multicast join information, and there is newly added multicast source information and multicast group information in a specific VLAN of the second multicast join information, the comparison result comprises the newly added multicast source information and multicast group information; and
when the first multicast join information is compared with the second multicast join information, and there is reduced multicast source information and multicast group information in a specific VLAN of the second multicast join information, the comparison result comprises the reduced multicast source information and multicast group information.

4. The method according to claim 3, wherein when the preset-protocol packet is an IGMP packet, the generating, according to the comparison result, a preset-protocol packet according to a preset format comprises:
generating, by the AGG according to the comparison result, an IGMP packet according to the preset format, wherein the preset format comprises: a V1 format, a V2 format, or a V3 format, wherein V1, V2, and V3 are IGMP version numbers.

5. The method according to claim 4, wherein
when the preset format is the V1 format or the V2 format, and there is the newly added multicast group information in the comparison result, the generating, according to the comparison result, an IGMP packet according to the preset format comprises:
generating, by the AGG, a first IGMP report packet according to the newly added multicast join information in the comparison result, wherein the first IGMP report packet is generated according to the newly added multicast group information;
when the preset format is the V3 format, and there is the newly added multicast group information in the comparison result, or there is the newly added multicast source information and multicast group information in the comparison result, the generating, according to the comparison result, an IGMP packet according to the preset format comprises:
generating, by the AGG, an allow packet according to the newly added multicast join information in the comparison result, wherein the allow packet is generated according to the newly added multicast group information or according to the newly added multicast source information and multicast group information;
when the preset format is the V1 format or the V2 format, and when there is the reduced multicast group information in the comparison result, the generating, according to the comparison result, an IGMP packet according to the preset format comprises:
generating, by the AGG, a leave indication packet according to the reduced multicast join information in the comparison result, wherein the leave indication packet is generated according to the reduced multicast group information; and
when the preset format is the V3 format, and when there is the reduced multicast group information in the comparison result, or there is the reduced multicast source information and multicast group information in the comparison result, the generating, according to the comparison result, an IGMP packet according to the preset format comprises:
generating, by the AGG, a leave packet according to the reduced multicast join information in the comparison result, wherein the leave packet is generated according to the reduced multicast group information or according to the reduced multicast source information and multicast group information.

6. The method according to claim 4, wherein
when the preset format is the V2 format, or when the preset format is the V3 format, the generating, according to the comparison result, an IGMP packet according to the preset format comprises:
receiving, by the AGG, a group-specific query packet sent by the first multicast router, wherein the group-specific query packet comprises a specific VLAN identifier; and
generating, by the AGG, a second IGMP report packet according to the comparison result, wherein the second IGMP report packet is generated according to the updated multicast join information that is stored in the AGG.

7. The method according to claim 4, wherein when the preset-protocol packet is a PIM packet,
when there is the newly added multicast group information in the comparison result, the generating, according to the comparison result, a preset-protocol packet according to a preset format comprises:
generating, by the AGG, a Protocol Independent Multicast service join message (PIM SM Join) according to the newly added multicast join information in the comparison result, wherein the PIM SM Join is generated according to the newly added multicast group information;
when there is the newly added multicast source information and multicast group information in the comparison result, the generating, according to the comparison result, a preset-protocol packet according to a preset format comprises:
generating, by the AGG, a Protocol independent multicast source specific join message (PIM SSM Join) according to the newly added multicast join information in the comparison result, wherein the PIM SSM Join is generated according to the newly added multicast source information and multicast group information;
when there is the reduced multicast group information in the comparison result, the generating, according to the comparison result, a preset-protocol packet according to a preset format comprises:
generating, by the AGG, a Protocol Independent Multicast service prune message (PIM SM Prune) according to the reduced multicast join information in the comparison result, wherein the PIM SM Prune is used to delete the reduced multicast group information; and
when there is the reduced multicast source information and multicast group information in the comparison result, the generating, according to the comparison result, a preset-protocol packet according to a preset format comprises:
generating, by the AGG, a protocol independent multicast source specific multicast prune message (PIM SSM Prune message) according to the reduced multicast join information in the comparison result, wherein the PIM SSM Prune is used to delete the reduced multicast source information and multicast group information.

8. An aggregation switch (AGG), wherein the AGG comprises a processor, a memory, and a network interface,
the memory is configured to store multicast join information that is updated last time, and store an instruction;
the processor is configured to execute the instruction and is configured to;
acquire a multicast group address link state protocol data unit (GM LSP) packet sent by an access switch (ACC);
compare multicast join information in the GM LSP packet acquired by the processor with the multicast join information in the memory, to obtain a comparison result, and update the multicast join information in the memory according to the comparison result;
when there is changed multicast join information in the comparison result, generate, according to the comparison result, a preset-protocol packet according to a preset format, wherein the preset-protocol packet is an Internet Group Management Protocol (IGMP) packet or a Protocol Independent Multicast (PIM packet); and
the network interface is configured to send the preset-protocol packet generated by the processor to a first multicast router, so that the first multicast router generates a multicast forwarding entry according to the preset-protocol packet.

9. The AGG according to claim 8, wherein
the GM LSP packet is a Transparent Interconnection of Lots of Links (TRILL) LSP packet; and the multicast join information in the GM LSP packet comprises: a virtual local area network (VLAN) identifier and multicast group information corresponding to the VLAN identifier, or the multicast join information in the GM LSP packet comprises: a VLAN identifier and multicast source information and multicast group information that are corresponding to the VLAN identifier.

10. The AGG according to claim 8, wherein the processor is configured to:
when the multicast join information in the GM LSP packet comprises a VLAN identifier and multicast group information corresponding to the VLAN identifier,
classify and combine, according to the VLAN identifier, the multicast join information stored in the memory, to obtain first multicast join information, wherein the first multicast join information is each VLAN identifier and multicast group information corresponding to each VLAN identifier that are stored in the AGG;
classify and combine, according to the VLAN identifier, the multicast join information in the GM LSP packet acquired by the processor, to obtain second multicast join information, wherein the second multicast join information is each VLAN identifier and multicast group information corresponding to each VLAN identifier that are in the GM LSP packet; and
compare the first multicast join information with the second multicast join information to obtain the comparison result, wherein the comparison result comprises:
when the first multicast join information is compared with the second multicast join information, and there is newly added multicast group information in a specific VLAN of the second multicast join information, the comparison result comprises the newly added multicast group information; and
when the first multicast join information is compared with the second multicast join information, and there is reduced multicast group information in a specific VLAN of the second multicast join information, the comparison result comprises the reduced multicast group information; or
when the multicast join information in the GM LSP packet comprises a VLAN identifier and multicast source information and multicast group information that are corresponding to the VLAN identifier,
classify and combine, according to the VLAN identifier, the multicast join information stored in the memory, to obtain first multicast join information, wherein the first multicast join information is each VLAN identifier and multicast source information and multicast group information corresponding to each VLAN identifier that are stored in the AGG;
classify and combine, according to the VLAN identifier, the multicast join information in the GM LSP packet acquired by the processor, to obtain second multicast join information, wherein the second multicast join information is each VLAN identifier and multicast source information and multicast group information corresponding to each VLAN identifier that are stored in the GM LSP packet; and
compare the first multicast join information with the second multicast join information to obtain the comparison result, wherein the comparison result comprises:
when the first multicast join information is compared with the second multicast join information, and there is newly added multicast source information and multicast group information in a specific VLAN of the second multicast join information, the comparison result comprises the newly added multicast source information and multicast group information; and
when the first multicast join information is compared with the second multicast join information, and there is reduced multicast source information and multicast group information in a specific VLAN of the second multicast join information, the comparison result comprises the reduced multicast source information and multicast group information.

11. The AGG according to claim 10, wherein when the preset-protocol packet is an IGMP packet, the processor is configured to:
generate, according to the comparison result, an IGMP packet according to the preset format, wherein the preset format comprises: a V1 format, a V2 format, or a V3 format, wherein V1, V2, and V3 are version numbers of the IGMP protocol.

12. The AGG according to claim 11, wherein
when the preset format is the V1 format or the V2 format, and there is the newly added multicast group information in the comparison result, the processor is configured to:
generate a first IGMP report packet according to the newly added multicast join information in the comparison result, wherein the first IGMP report packet is generated according to the newly added multicast group information;
when the preset format is the V3 format, and there is the newly added multicast group information in the comparison result or there is the newly added multicast source information and multicast group information in the comparison result, the processor is configured to:
generate an allow packet according to the newly added multicast join information in the comparison result, wherein the allow packet is generated according to the newly added multicast group information or according to the newly added multicast source information and multicast group information;
when the preset format is the V1 format or the V2 format, and when there is the reduced multicast group information in the comparison result, the processor is configured to:
generate a leave indication packet according to the reduced multicast join information in the comparison result, wherein the leave indication packet is generated according to the reduced multicast group information; and
when the preset format is the V3 format, and when there is the reduced multicast group information in the comparison result, or there is the reduced multicast source information and multicast group information in the comparison result, the processor is configured to:
generate a leave packet according to the reduced multicast join information in the comparison result, wherein the leave packet is generated according to the reduced multicast group information or according to the reduced multicast source information and multicast group information.

13. The AGG according to claim 11, wherein
when the preset format is the V2 format, or when the preset format is the V3 format, the processor is configured to:
receive a group-specific query packet sent by the first multicast router, wherein the group-specific query packet comprises a specific VLAN identifier; and
generate a second IGMP report packet according to the comparison result, wherein the second IGMP report packet is generated according to the updated multicast join information.

14. The AGG according to claim 11, wherein when the preset-protocol packet is a PIM packet,
when there is the newly added multicast group information in the comparison result, the processor is configured to:
generate a Protocol Independent Multicast service join message (PIM SM Join) according to the newly added multicast join information in the comparison result, wherein the PIM SM Join is generated according to the newly added multicast group information;
when there is the newly added multicast source information and multicast group information in the comparison result, the processor is configured to:
generate a Protocol Independent Multicast source specific join message (PIM SSM Join) according to the newly added multicast join information in the comparison result, wherein the PIM SSM Join is generated according to the newly added multicast source information and multicast group information;
when there is the reduced multicast group information in the comparison result, the processor is configured to:
generate a Protocol Independent Multicast service prune message (PIM SM Prune) according to the reduced multicast join information in the comparison result, wherein the PIM SM Prune is used to delete the reduced multicast group information; and
when there is the reduced multicast source information and multicast group information in the comparison result, the processor is configured to:
generate a Protocol Independent Multicast source specific multicast prune message (PIM SSM Prune) according to the reduced multicast join information in the comparison result, wherein the PIM SSM Prune is used to delete the reduced multicast source information and multicast group information.
